(19) United States
(12) Patent Application Publication
(10) Pub. No.: US 2024/0144243 A1
(43) Pub. Date: May 2, 2024

(54) SYSTEM FOR GENERATING A BLOCKCHAIN TOKEN ASSOCIATED WITH A REDEMPTION CODE

(71) Applicant: Midtown Fashion Co., Washington, DC (US)

(72) Inventors: Kyle Zappitell, New York, NY (US); Blake Levine, Detroit, MI (US)

(21) Appl. No.: 18/111,522

(22) Filed: Feb. 17, 2023

Related U.S. Application Data
(60) Provisional application No. 63/421,116, filed on Oct. 31, 2022.

(51) Int. Cl. G06Q 20/36; G06Q 20/38

(52) U.S. Cl. CPC G06Q 20/3672; G06Q 20/3678; G06Q 20/3825; G06Q 20/389

(57) ABSTRACT

A system for generating a blockchain token associated with a redemption code, the system having a computing system, a user interface, and a datastore. The system is configured to receive a selection of a digital asset and a payment in fiat currency for the blockchain token; create a draft token document with token metadata including the digital asset; generate a redemption code uniquely associated with the token document, and output the redemption code; the system responsive to receiving the redemption code from the user interface causes a blockchain token to be generated based on the token document; and, the blockchain token uniquely associated with the digital asset.

### CROSS REFERENCE TO RELATED APPLICATIONS

This application claims the benefit of U.S. Provisional Patent Application 63/421,116, filed Oct. 31, 2022, which is hereby incorporated by reference in its entirety.

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is directed to a system for generating blockchain tokens, including non-fungible tokens, in exchange for a unique redemption code.

### BRIEF SUMMARY OF THE INVENTION

The present invention enables a user, without using digital money or cryptocurrency, to choose, pay for, generate, and own, tokens (interchangeably referred here as blockchain tokens) on a blockchain (e.g., Bitcoin, Solana, Ethereum, etc.), including Non Fungible Tokens (NFTs) and other types of tokens. Embodiments of the present invention comprise a computing system and a user interface (e.g., on a client device, such as computer, mobile device, token ATM, NFT ATM, vending machine, and others) enabling the selection a digital asset (including any digital file, e.g., image, artwork, multimedia, music, document) to be associated with, or converted to, a blockchain token. The user interface may be configured to accept payment sufficient to cover blockchain fees associated with the blockchain token generation. Payment may be made with any digital or non-digital asset. In a preferred embodiment, payment is made in fiat currency instead of digital currency, such as cryptocurrency, or other digital representation of value. In exchange for payment, embodiments of the present invention may generate a redemption code and output the redemption code, for example, in the form of a voucher, QR code, bar code, and others. The redemption code may be redeemed to initiate the generation of the blockchain token associated with the digital asset. A master wallet (or master account) associated with the blockchain of the blockchain token may be credited a quantity of a cryptocurrency (e.g., “SOL” for the Solana network, “BTC” for the Bitcoin Network, and others) corresponding to the payment in fiat currency. Preferably the cryptocurrency is an acceptable method of paying blockchain fees—such as gas fees, network fees, transmission fees, and other blockchain fees—without conversion.

Embodiments of the invention are configured to generate and store a token document representing a draft, or a temporary copy, of the information necessary to generate the blockchain token. The token document may comprise draft token metadata, information about the digital asset to be associated with the blockchain token, identification of the master wallet associated with the blockchain, whether the blockchain token will be a fungible or non-fungible token, the quantity of blockchain token supply (e.g., how many blockchain tokens can be created), whether creation of additional blockchain tokens is authorized, who has creation authority, and other relevant information. The token document may also be associated with the redemption code. Embodiments of the present invention are configured to generate the blockchain token according to the information stored in the token document in response to receiving the redemption code associated with the token document.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a diagram illustrating an embodiment of the present invention.

FIG. 2 is a diagram illustrating an embodiment of the present invention.

FIG. 3 is a diagram illustrating a process flow according to an embodiment of the present invention.

FIG. 4 is a diagram illustrating a process flow according to an embodiment of the present invention.

FIG. 5 is a diagram illustrating several aspects of an embodiment of the present invention.

FIG. 6 is a diagram illustrating an embodiment of the present invention.

FIG. 7 is a diagram illustrating a digital asset selection according to an embodiment of the present invention.

FIG. 8 is a diagram illustrating a redemption according to an embodiment of the present invention.

For clarity all reference numerals may not be included in every figure.

### DETAILED DESCRIPTION OF THE INVENTION

The present invention is directed to a system 1 for generating a blockchain token 20 associated with a redemption code 9. Embodiments of the invention may also be configured to enable one or more of selecting a digital asset 10 to be uniquely associated with a blockchain token 20, generating a token document 21 comprising draft (or temporary) token metadata 22, and generating a redemption code 9 uniquely associated with the token document 21.

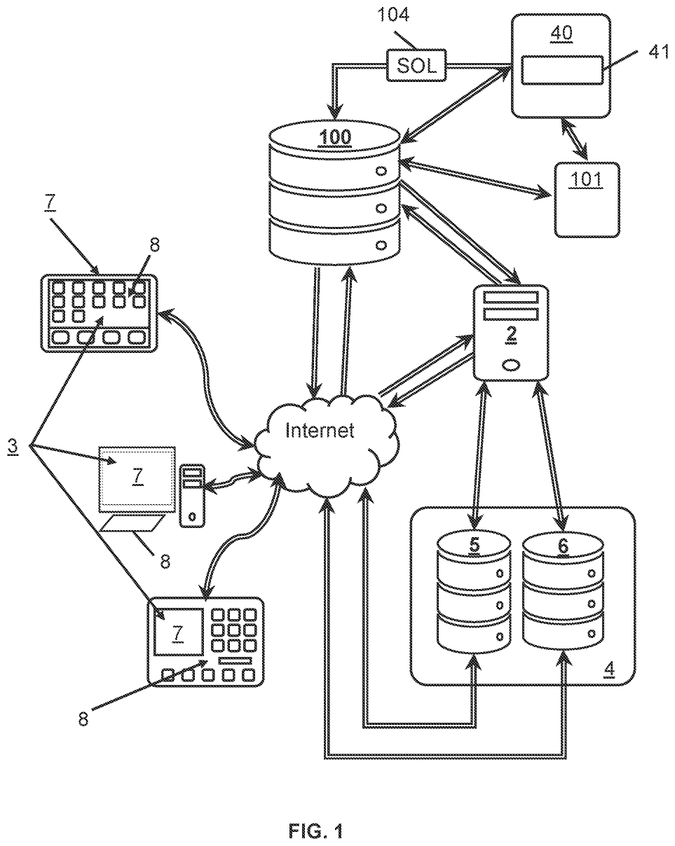

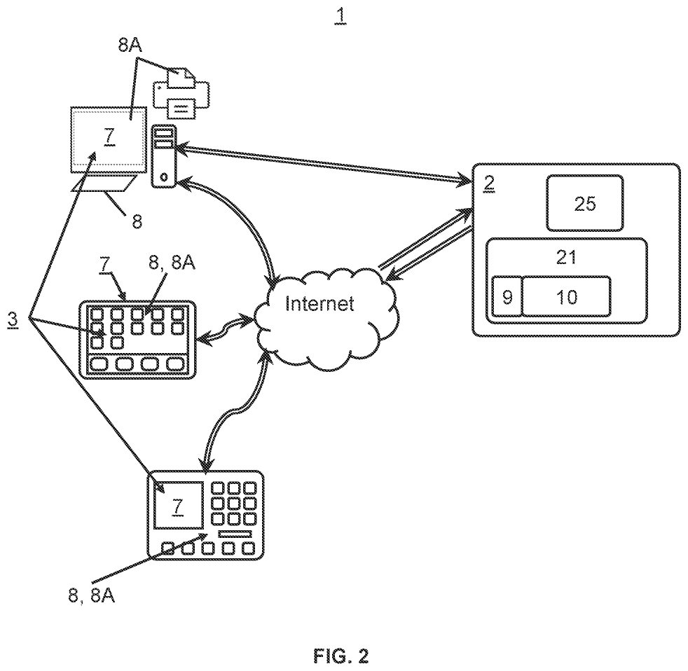

As illustrated in FIGS. 1, 2, embodiments of system 1 may comprise computing system 2 and user interface 3 in data communication with each other (over, e.g., a direct connection, a network, the Internet). Computing system 2 and user interface 3 preferably are in data communication with a datastore 4. Datastore 4 may comprise database 5 and application database 6. Computing system 2 preferably also is in data communication with blockchain 100. Data communications are illustrated by double-line arrows in FIGS. 1 and 2.

Embodiments of system 1 illustrated in FIG. 5 may comprise redemption code 9, digital asset 10 having digital asset identifier 11, and token document 21 comprising the digital asset identifier 11. Token document 21 may further comprise token metadata 22. System 1 may also comprise master wallet 40, user wallet 30, and token transaction 25. Datastore 4 may store one or more of token document 21 and digital asset 10.

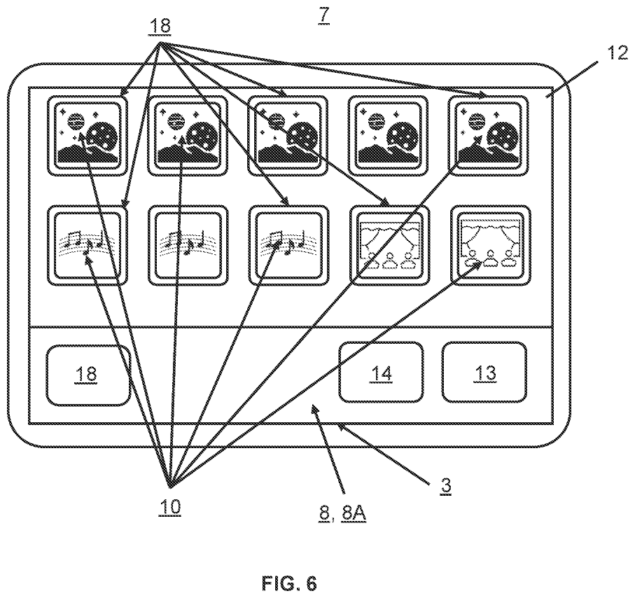

FIG. 6 illustrates user interface 3 in an embodiment configured to operate on client device 7 having input device 8 (e.g., touchscreen) and output device 8A (e.g., display). Client device 7 may be any device, such as a computer, a mobile device, a wearable, an automated teller-type device (e.g., ATM), a vending machine, a payment kiosk, and other client devices 7 capable of outputting information to a user and receiving input from a user. Client device 7 and computing system 2 are in data communication and may be located adjacent to each other, or may be in distant different geographic locations, for example with a computing system located in one or more server facilities, and one or more client devices 7 carried by users, or located in public locations, offices, homes, and others.

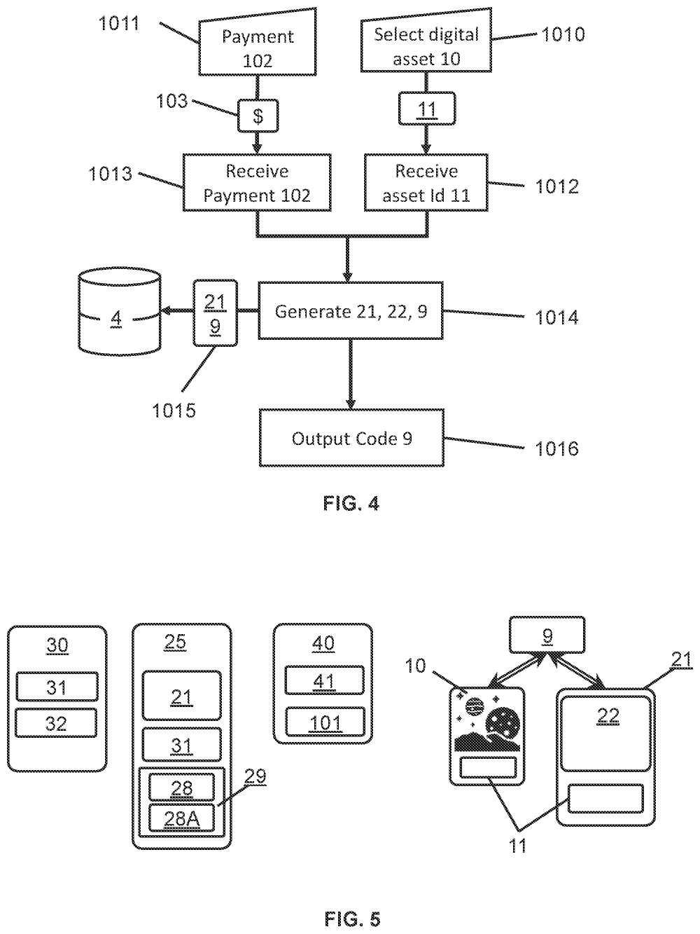

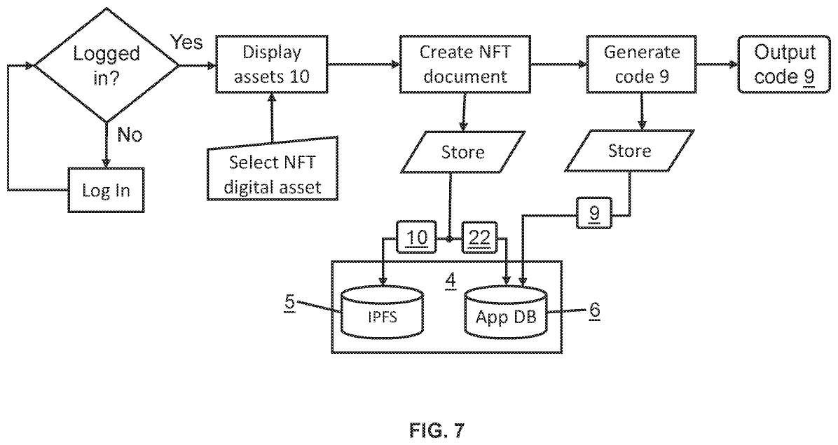

Embodiments of user-Interface 3 may be configured to allow a user to select a digital asset 10 to be associated with blockchain token 20. For example, FIG. 7 illustrates an embodiment of computing system 2 configured to transmit to user interface 3 and cause it to output on client device 7 a plurality of digital assets 10. User interface 3 may output the plurality of digital assets 10 through output device 8A, for example visually on a display, as sound through a speaker, tactile output through a tactile or sensory type output, and other output devices as appropriate based on the form and type of the plurality digital assets 10. User interface 3 may also comprise a user control 18 associated with digital asset 10. FIG. 4 illustrates an embodiment of the present invention. In step 1010, activating user control 18 on client device 7 indicates that a user has selected a digital asset 10 to be associated with a blockchain token 20, which the user desires to purchase. In step 1011 user interface 3 may be configured to allow a user to submit payment 102, and in step 1013 computing system receives payment 102 in fiat currency 103. In step 1012 user interface 3 may be configured, in response to activating the user control 18 and selecting a digital asset 10, to transmit to computing system 2 digital asset identifier 11 of the digital asset 10. Computing system 2 receives from the user interface 3 the digital asset identifier 11, and in step 1014 computing system 2 may generate a token document 21 comprising token metadata 22 and the digital asset identifier 11. In step 1014 computing system 2 may also generate redemption code 9 uniquely associated with the token document 21. In step 1015 computing system 2 may cause token document 21 and the redemption code 9 to be stored in datastore 4, for example in application database 6. In step 1016, user interface 3 outputs redemption code 9 through output device 8A (as, e.g., a voucher, an alphanumeric sequence, a barcode, a QR code, and others). Computing system 2 may be configured to deposit into master wallet 40 cryptocurrency 101 in a quantity corresponding to the payment 102. Computing system 2 may deposit cryptocurrency 101 into master wallet 40 responsive to one or more of receiving payment 102, receiving redemption code 9 from user interface 3, and receiving digital asset identifier 11 from user interface 3.

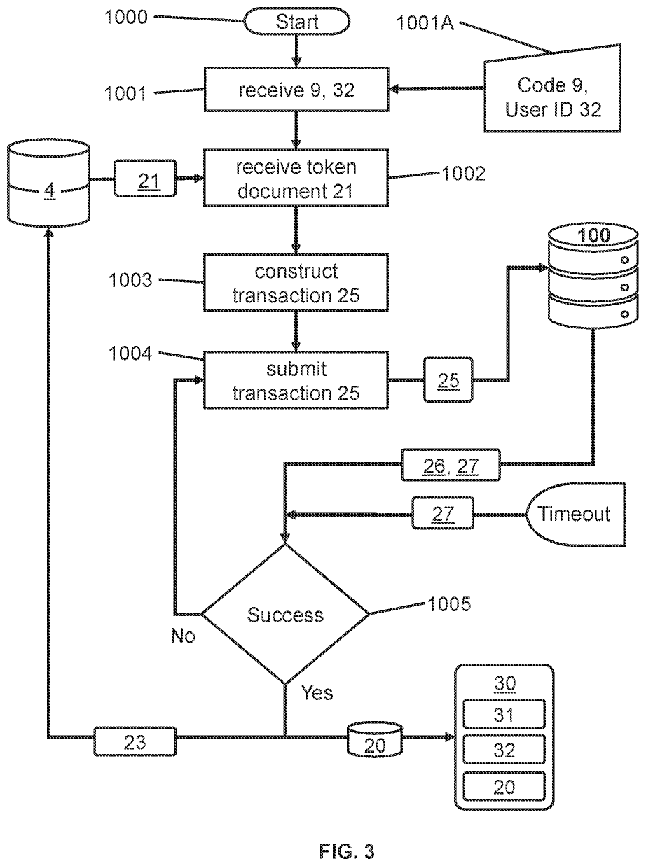

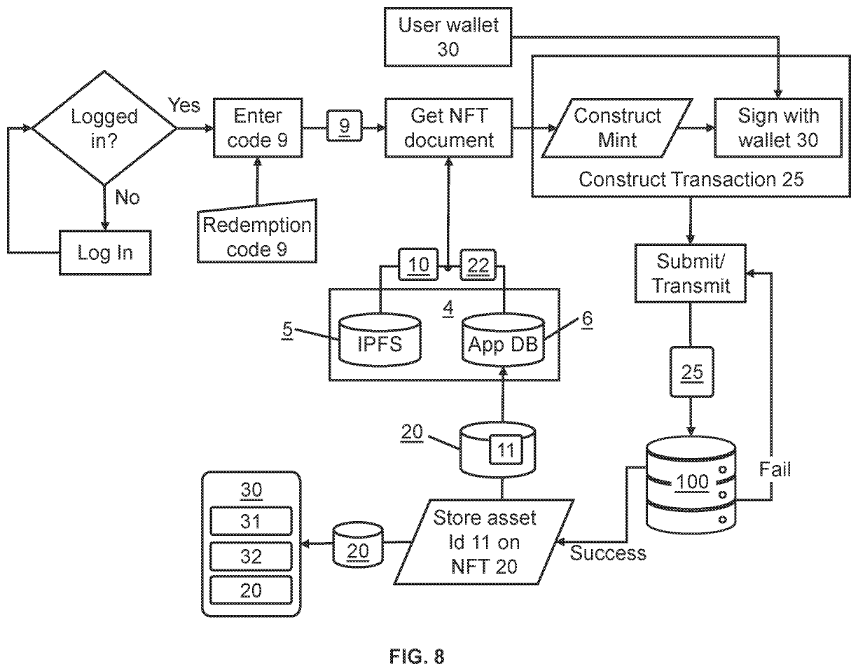

FIG. 8 illustrates an embodiment of user interface 3 configured to enable a user to use redemption control 14 and input device 8 to enter a redemption code 9. A redemption according to an embodiment of the invention is illustrated in FIG. 3. In step 1001, computing system 2 may receive the redemption code 9 and user ID 32 (e.g., associated with log-in credentials) from the user interface 3, entered in step 1001A using input device 8 and redemption control 14. In response to receiving the redemption code 9, in step 1002 computing system 2 may be configured to receive from datastore 4 token document 21 associated with the redemption code 9. In step 1003 a token transaction 25 is constructed, comprising the token document 21, master wallet address 41 associated with master wallet 40, and user wallet signature 31 of user wallet 30. Responsive to receiving the redemption code 9 computing system 9 may also be configured to retrieve from datastore 4 the digital asset 10 associated with the digital asset identifier 11.

In step 1004, responsive to receiving redemption code 9 computing system 2 may be configured to submit the token transaction 25 to blockchain 100, thereby instructing the blockchain 100 to initiate the creation of blockchain token 20 according to token transaction 25 (based, e.g., on the token document, fungibility indicator 29, supply indicator 28, or other information contained in the token transaction 25).

In step 1005, computing system 2 is configured to receive from blockchain 100 a success indicator 26 for the token transaction 25 indicating that the blockchain token 20 was successfully created on the blockchain 100 according to the information and instructions in token transaction 25. Upon the successful creation of blockchain token 20, indicated as “yes” in step 1005, token 20 may be deposited to the user wallet 30 (i.e., associated with user wallet signature 31), and digital asset 10 would be uniquely associated with the blockchain token 20. Responsive to receiving success indicator 26 in step 1005 (indicated as “yes”) computing system 2 causes datastore 4 (e.g., application database 6) to store token identifier 23 for the blockchain token 20. In step 1005 computing system 2 may also be configured to receive a failure indicator 27 for transaction 25 if blockchain token 20 was not properly created. Responsive to receiving failure indicator 27 in step 1005 (indicated as “No”) computing system 2 may return to step 1004 and submit the token transaction 25 to the blockchain 100. Failure indicator 27 may be received from blockchain 100, may be a result from a timeout if a success indicator 26 is not received after a certain time, or failure indicator 27 may be provided by various other methods.

User identifier 32 may be associated with an existing user wallet 30 and its user wallet signature 31. Also, in response to receiving user identifier 32, computing system 2 may be configured to create, or generate, a new user wallet 30 having new user wallet signature 31, and to associate the user identifier 32 with the new user wallet 30.

Embodiments of computing system 2 may construct token transaction 25 further comprising a fungibility indicator 29, which may be a non-fungible indicator 29, a fungible indicator 29, or a semi-fungible indicator 29. Non-fungible indicator 29 indicates that token transaction 25 is instructing blockchain 100 to create a non-fungible token 20, or an NFT 20, based on the information contained in the token document. Fungible indicator 29 may be an instruction to blockchain 100 to create a fungible token 20 based on token document 21. Semi-fungible indicator 29 indicates to the blockchain 100 to create a semi-fungible token 20 based on token document 21. Token transaction 25 may comprise a supply indicator 28 comprising a token supply (or quantity) 28A of blockchain token 20 (i.e., how many blockchain tokens 20 may be created by the blockchain 100). Supply indicator 28 may also comprise token creation authority 28B indicating whether creating additional blockchain tokens 20 is authorized, and who has the authority to create the additional tokens 20. In some embodiments fungibility indicator 29 may comprise supply indicator 28. For example, fungibility indicator 29 comprising a token supply 28A of one (i.e., 1, a single token) and token creation authority 28B banning the creation of additional blockchain tokens 20 may be a non-fungible indicator 29 resulting in the creation of an NFT.

Embodiments of the present invention may be configured to receive a payment in fiat currency 103, instead of digital currency, such as cryptocurrency, tokens, or coins, to generate blockchain token 20. Computing system 2 may be in data communication with master wallet 40 associated with blockchain 100. Master wallet 40 preferably accepts deposits in a cryptocurrency 101. Cryptocurrency 101 may be associated with blockchain 100, for example by being accepted for paying fees 104 (e.g., gas fees, transmission fees, network fees, other blockchain fees) for blockchain 100, or cryptocurrency 101 may be native to blockchain 100. Computing system 2 may be configured to receive from user interface 3 payment 102 in fiat currency 103 (e.g., USD), and deposit into master wallet 40 a quantity of cryptocurrency 101 corresponding (e.g., based on an exchange rate) to the amount of fiat currency 103 in payment 102.

Computing system 2 may comprise one or multiple computing systems 2, including webservers, application servers, personal computers, mobile devices, distributed computing systems, and combinations thereof. Each of datastore 4, database 5, and application database 6 may comprise (e.g., locally, remotely) one or more databases, content delivery networks (CDN), distributed storage systems, network based data storing and sharing system (e.g., IPFS), and combinations thereof. Client device 7 may be any computing device (mobile or otherwise) that a user 10 may use to access system 1.

User interface 3 may comprise hardware and/or software components, including personal computers, mobile devices, thin clients, NFT ATMs, browsers, operating systems, graphical user interface programs, and combinations of the foregoing. User interface 3 may also comprise one or more input devices 8 (e.g., keyboard, touch interface, wired or wireless communication ports, sound/voice interface, artificial vision, scanner, etc.) and one or more output devices 8A (e.g., printers, displays, speakers, sound output, wired/wireless communication ports, etc.).

Token document 21 may be a draft, or temporary, token information and may comprise draft, or temporary, token metadata 22, including token ID (e.g, UUID), token addresses (e.g., from address “0” for creation), digital asset type, digital asset description, digital asset identifier 11 (URI, IPFS CID), and other appropriate information to enable blockchain 100 to generate blockchain token 20 in unique association with digital asset 10. Redemption code 9 may be any code (e.g., alphanumeric, bar code, QR, biometric code, face, fingerprint, and others) that can uniquely be associated with the token document 21.

Blockchain 100 may be any cryptographic blockchain (e.g., Bitcoin, Solana, Ethereum) that enables the creation of new blockchain tokens. Blockchain 100 as used herein includes one or more blockchain servers, blockchain applications, cryptographically secured blockchain data (e.g., ledger), as well as any front and backend software and hardware used or necessary for the proper functioning of blockchain 100. Blockchain cryptocurrency 101 refers to digital units used associated with blockchain 100, for example for blockchain fees 104 associated with running token transaction 25 (e.g., generating a token) on blockchain 100. Blockchain token 20, as used herein, may be either coin or token depending on blockchain 100.

Token transaction 25 may be a set of one or more software instructions, used to transmit to blockchain 100 commands and information necessary to generate a new blockchain token. Token transaction 25 may be referred to as a “mint” or “mint transaction” depending on the type of blockchain 100.

While the invention has been described with reference to exemplary embodiments, it will be understood by those skilled in the art that various changes, omissions, and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiments disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A system for generating a blockchain token associated with a redemption code, the system comprising:
a user interface;
a computing system, in communication with the user interface;
wherein the computing system is in data communication with a blockchain;
wherein the blockchain accepts fees in a cryptocurrency; and,
wherein the blockchain is associated with a master wallet having a master wallet address;
a datastore storing a token document;
wherein the token document comprises token metadata and a digital asset identifier; and,
wherein the digital asset identifier is associated with a digital asset; and,
a redemption code uniquely associated with the token document;
wherein the user interface receives the redemption code and a user identifier;
wherein responsive to the user interface receiving the redemption code, the computing system is configured to:
(a) receive the token document from the datastore;
(b) construct a token transaction comprising the token document and a user wallet signature;
(c) wherein the user wallet signature is associated with the user identifier; and,
(d) submit the token transaction to the blockchain;
wherein the computing system is configured to receive from the blockchain a success indicator for the token transaction indicative of a successful creation on the blockchain of the blockchain token according to the token transaction;
wherein responsive to receiving the success indicator the computing system is configured to:
(a) deposit the blockchain token to a user wallet associated with the user wallet signature; and,
(b) store a token identifier for the blockchain token to the datastore; and,
wherein the blockchain token is uniquely associated with the digital a.

2. The system of claim 1, wherein the user interface is configured to receive a payment in fiat currency;
wherein the computing system is configured to deposit into the master wallet a quantity of a cryptocurrency corresponding to the payment; and,
wherein the token transaction further comprises the master wallet address.

3. The system of claim 2, wherein responsive to the user interface receiving the redemption code the computing system is further configured to:
(a) create the user wallet having the user wallet signature; and,
(b) deposit into the master wallet a quantity of a cryptocurrency corresponding to the payment.

4. The system of claim 3, wherein the computing system is configured to receive from the user interface the digital asset identifier; and,
wherein the computing system is configured, responsive to receiving one or more of the digital asset identifier and payment to:
(a) generate the token metadata;
(b) generate the token document;
(c) generate the redemption code uniquely associated with the token document;
(d) store into the datastore the token document and the redemption code; and,
(e) cause the user interface to output the redemption code.

5. The system of claim 4, wherein the computing system is configured to receive a transaction failure indicator indicative of a failed creation of blockchain token on the blockchain; and,
wherein the computing system is configured, responsive to receiving the transaction failure indicator, to submit the token transaction to the blockchain.

6. The system of claim 5, wherein the token transaction further comprises a fungibility indicator;
wherein the fungibility indicator is selected from a non-fungible indicator, fungible indicator, and semi-fungible indicator;
wherein a non-fungible indicator indicates that the blockchain token is a unique token;
wherein a fungible indicator indicates that the blockchain token is a fungible token; and,
wherein a semi-fungible indicator indicates that the blockchain token is a semi-fungible token.

7. The system of claim 6, wherein the user interface comprises a client device;
wherein the client device and the computing system are located in different geographic locations;
wherein the user interface comprises a user control associated with the digital asset;
wherein the computing system is configured to cause the user interface to output a plurality of digital assets on the client device;
wherein the plurality of digital assets comprises digital asset; and,
wherein the user interface is configured, in response to activating the user control on the client device, to transmit the digital asset identifier to the computing system.

8. The system of claim 7, wherein the user interface further comprises a payment control;
wherein the payment control is configured to accept payment in the fiat currency on the client device; and,
wherein the user interface is configured, in response to payment control accepting the payment, to cause the payment to be transmitted to the computing system.

9. The system of claim 5, wherein the token transaction further comprises a supply indicator;
wherein the supply indicator comprises a token supply; and,
wherein the success indicator is indicative of the successful creation of the token supply of the blockchain token on the blockchain.

10. The system of claim 9, wherein the supply indicator further comprises a token creation authority; and,
wherein the success indicator is indicative of the successful creation of the token supply quantity of the blockchain token with the token creation authority on the blockchain.
